(19) United States
(12) Patent Application Publication
(10) Pub. No.: US 2008/0313653 A1
(43) Pub. Date: Dec. 18, 2008

(54) PRINTER DATA STREAM TUNNELING FOR PRINT WORKCELL DEVICE CONTROL

(75) Inventors: Kevin T. Malone, Folsom, CA (US); Frank W. Delfer, Granite Bay, CA (US)

Correspondence Address: JOHN P. O'BANION;O'BANION & RITCHEY LLP, 400 CAPITOL MALL SUITE 1550, SACRAMENTO, CA, 95814, US

(73) Assignee: DST OUTPUT, El Dorado Hills, CA (US)

(21) Appl. No.: 12/138,663

(22) Filed: Jun. 13, 2008

Related U.S. Application Data
(60) Provisional application No. 60/934,788, filed on Jun. 14, 2007.

(51) Int. Cl. G06F 9/44

(52) U.S. Cl. 719/319

(57) ABSTRACT

A system and method are disclosed for a printing system that embeds tunneled messages into a data stream transferred along a data path. The embedded messages direct the operation of an associated system or device along the data path. The embedded messages are inserted No Operation or similar commands embedded by a preprocessor into the data stream and then emitted in a printing workcell for controlling the printer or associated system or device.

### CROSS-REFERENCE TO RELATED APPLICATIONS

This application claims priority from U.S. provisional application Ser. No. 60/934,788 filed on Jun. 14, 2007, incorporated herein by reference in its entirety.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to “printer data stream” (PDS) tunneling protocols that embed control directives into a data stream, thereby regulating the operation of various mechanisms used in a print workcell and creating a general purpose mechanism to bypass logic within 3^{rd} party systems for custom print output. Additionally, the subject embedded control directives can be closely synchronized with print job images and can provide instructions for quality checking or printing systems that print text or symbols on specific documents.

2. Description of Related Art

Currently, the highest speed variable data printing is accomplished using file based protocols commonly called “printer data streams” (PDS). There are a number of very different de facto standard protocols that have been developed over the last 30 years. Printing companies use complex third party software products to transform customer PDS input formats to PDS output formats usable by their printers. However, these third party products, including the printer controllers, are “black boxes” that can form a barrier to rapid introduction of new and proprietary technologies that give printing companies strategic advantages.

The diagram shown in FIG. 1 (Prior Art) schematically illustrates a typical existing configuration for a provider (for example, a printing and bulk mailing facility) who processes data for a customer (for example, a company that needs to have billing statements mailed to its users). The system diagrammed in FIG. 1 is based on the printing provider obtaining document printing data from the customer. Customer PDS Output CO (for example, utilizing Advanced Function Presentation (AFP) compatible system which provides a standard print management architecture that interacts with printers in a device-independent and object-oriented manner) is accessed from the customer and transferred via a Public Network PU to a PDS Preprocessor PP (for example, a provider's own factory systems). The output of the PDS Preprocessor PP is transferred via a Production Network PN to a PDS Transformer T (for example, Emtex VIP (Virtual Intelligent Presentation) transform software and the like which converts each input stream into a discrete output format). The output of the PDS Transformer T is then transferred via a Workcell Network WN to Printer Controllers PC (for example, a Kodak CS410 and AdPhos Transport Controller and the like) which then controls the operation of an associated Printer PR (for example, a Kodak DS3700 and the like).

### BRIEF SUMMARY OF THE INVENTION

An object of the present invention is to provide a PDS tunneling protocol system that creates the capability to embed control directives in a data stream for mechanisms used in a print workcell.

Another object of the present invention is to furnish a PDS tunneling protocol system that creates the capability to embed control directives in a data stream for proprietary mechanisms used in a print workcell.

A further object of the present invention is to supply a PDS tunneling protocol system that creates a general purpose mechanism to bypass logic within 3^{rd} party systems for custom print output.

Still another object of the present invention is to disclose a combined PDS tunneling protocol system that creates both the capability to embed control directives in a data stream for mechanisms used in a print workcell and a general purpose mechanism to bypass logic within 3^{rd} party systems for custom print output.

Yet a further object of the present invention is to describe a PDS tunneling protocol system that embeds messages in No Operation (NOP) commands (or equivalent commands) by a preprocessor and then emits them in the workcell for use by a specific operational system or device.

Disclosed is a system and method for a printing system that embeds tunneled messages into a data stream transferred along a data path. The embedded messages direct the operation of an associated system or device along the data path. The embedded messages comprise inserted NOP commands embedded by a preprocessor into the data stream and then emitted in a printing workcell for controlling the associated system or device.

Further objects and aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a PRIOR ART block diagram showing a typical existing printer data stream technique for controlling a printer.

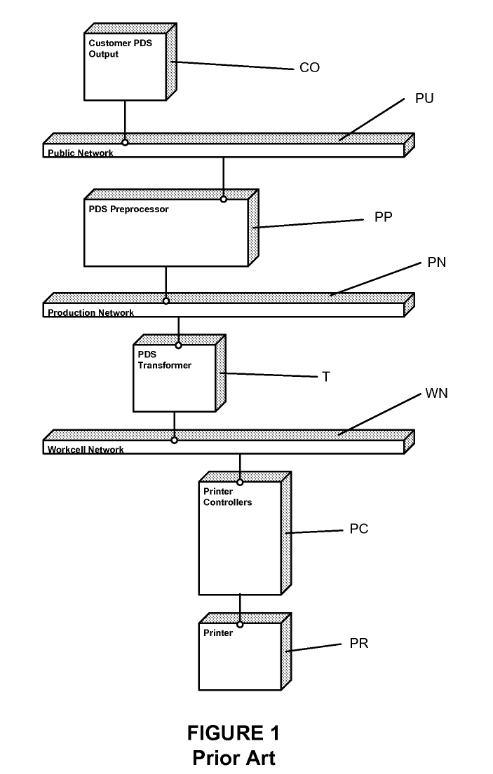

FIG. 2 shows a three layered command envelope structure for the subject invention with three levels of protocol supported.

FIG. 3 illustrates, in general, the subject invention's use of PDS tunneling in an exemplary block diagram.

FIG. 4 shows, for the subject invention, one specific embodiment illustrating a Level 1 & 2 tunneling application for proprietary print subsystem control in an exemplary block diagram.

### DETAILED DESCRIPTION OF THE INVENTION

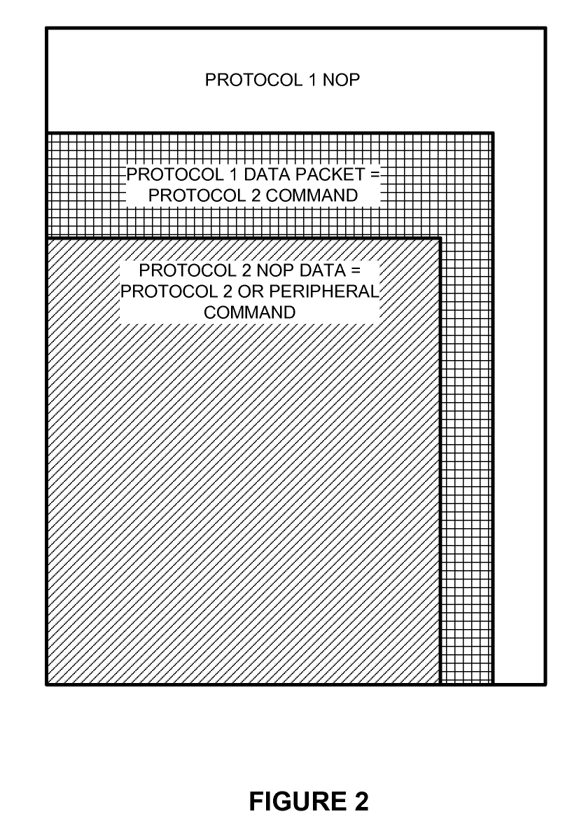

Referring more specifically to the drawings, for illustrative purposes the present invention is embodied in the system and method generally shown in FIG. 2 through FIG. 4. It will be appreciated that the system and method may vary as to configuration and as to details of the components, and that the method may vary as to the specific steps and sequence, and that the method may vary as to the details of the protocol syntax, without departing from the basic concepts as disclosed herein.

This disclosure describes a PDS tunneling protocol that creates at least two distinct advantages for a printing company utilizing the subject invention: 1) PDS tunneling creates the capability to embed control directives in a data stream for proprietary mechanisms and systems used in a print workcell and 2) PDS tunneling implementation creates a general purpose mechanism to bypass logic within 3^{rd} party systems for easily creating custom print output. The embedded control directives can be closely synchronized with print job images and can provide instructions for quality checking or printing systems/devices that are specific to each image. Because the directives are enveloped in “No Operation” (NOP) commands (or equivalent commands), they are logically decoupled from 3^{rd} party system processes. The only requirement of these 3^{rd} party systems into which the subject tunneling occurs is that they recognize the NOP intent and forward it via the correct channel regardless of payload content. Since there is no dependency on the payload content, the protocol can be used for ad hoc applications without change to the forwarding systems. Thus, it is understood that when the term “NOP” command is used other equivalent commands may also be utilized and are considered within the realm of this disclosure and the enumerated claims.

Specifically, for print workcell applications and equivalent situations, the subject invention utilizes the overall framework of the PDS as a signaling mechanism for associated systems and devices along the flow of work in a print job. Tunneled messages intended for various systems and devices along the data path are embedded using No Operation commands (NOPs) by the preprocessor. The preprocessor normally performs functions such as grouping, sorting, indexing, and inserting data associated with specific images. During this process, the preprocessor may also insert the tunneling protocol NOPs. Preprocessor logic driven by a knowledge of the customer, the customer's data, and parameter objects, provides an easily configurable system for tunneling protocol NOP insertion. These NOPs are used to create commands for downstream devices that implement proprietary print functions, customers' service level agreements, and printing company internal quality standards. During normal production workflow, the tunneling protocol NOPs are inspected at downstream nodes in the network, e.g. the PDS Transformer and the Printer Controllers. Each NOP payload contains a unique series of characters that flag the content for processing. Level 1 content also includes a target device identifier which is used to forward the payload to external workcell peripherals. The commands are then emitted in the workcell for use by the specific system or device. Level 3 and 2 content is merged with the customer's file contents for normal PDS processing downstream. Level 1 content is emitted via a physical channel to the workcell peripheral. For instance, the payload may be communicated using TCP/IP or SNMP communications though the system is not limited to any specific means of communication.

Protocols 1 and 2 may be in any PDS formats that do or can implement NOPs (or similar commands for transparent data transfer). In the examples herein, Protocol 1 is based on the Mixed Object Document Content Architecture (MO:DCA) standard developed by International Business Machines. MO:DCA includes definitions for presentation text, image, graphic, barcode, and font objects. Advanced Function Presentation (AFP) is a combination of products and services which enable this architecture and implement the associated PDS file formats. In the examples herein, Protocol 2 is based on Kodak Versamark's IJPDS file format specification. This format defines the file structure, commands and data formats that are required to drive Kodak Versamark printers. Similar to AFP, the file format includes handling of fonts, text, bit mapped symbols, etc.

For example and not by way of limitation, as illustrated in FIG. 2, PDS tunneling is a multi-level protocol with three levels defined as follows (additional and varied levels are contemplated as being within the realm of this disclosure):

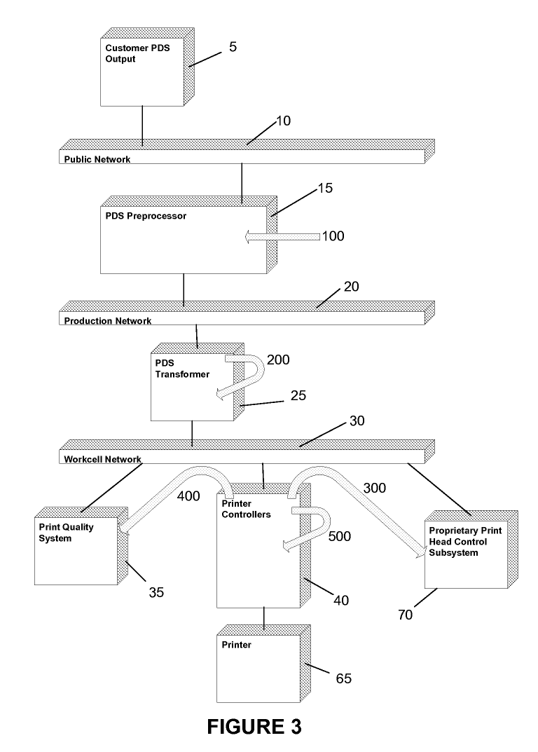

Level 1: Level 1 commands are to be passively forwarded by the Printer Controllers and are not generally Protocol 1 or 2 PDS commands (see FIG. 3, 300 and 400). These are commands embedded in Protocol 2 NOPs for control of peripheral subsystems in the print workcell (i.e., not the primary printer itself). For example, Protocol 2 might be an IJPDS (Kodak's Ink Jet Printer Data Stream) NOP with a payload of a target system identifier coupled with symbols for a magnetic ink character recognition (MICR) print head.

Level 2: Level 2 commands are to be actively processed by the Printer Controllers and included in its output PDS (see FIG. 3, 500). These are commands embedded in Protocol 2 NOPs that are Protocol 2 commands (generally other than Protocol 2 NOPs) which must be included in the PDS for the printer. For exemplary purposes only and not by way of limitation, these could be bitmaps for printing on the current page image using an IJPDS IBM (Image Bit Map) command.

Level 3: Level 3 commands are to be actively processed by the PDS Transformer and included in its output PDS (see FIG. 3, 200). These are commands embedded in Protocol 1 NOPs that are Protocol 2 commands which are included in the PDS by a PDS Transformer, processed by a printer controller, and printed by a primary printer. As an example and not a limitation, if Protocol 1 is AFP, the AFP NOP might contain an IJPDS IBM as its payload for inclusion in the data stream by the PDS Transformer.

Within a print file, all three protocol levels may be present, each may be present individually, or they may be present in any combination. See FIG. 3 for a block-diagram formatted description (described in detail below).

As seen in FIG. 2, the subject invention's protocol is structured so that commands intended for downstream systems and devices are enveloped (a command envelope) at multiple levels for interpretation by the appropriate system or device.

The block diagram shown in FIG. 3 discloses one example of how the subject invention interfaces and modifies the general flow of operations, commands, and actions used for specific printing jobs. A Customer PDS Output 5 is transferred via a Public Network 10 to a PDS Preprocessor 15. As highlighted in FIG. 3 by arrow 100, the PDS Preprocessor 15 inserts Protocol 1 NOPs and associated payloads for interpretation by the PDS Transformer 25 and/or Printer Controllers 40.

The information is then transferred via a Production Network 20 to the PDS Transformer 25. As highlighted in FIG. 3 by arrow 200, the PDS Transformer 25 inspects the transferred Protocol 1 NOPs and incorporates Level 3 commands into the data stream for the Printer Controller 40. Otherwise, the PDS Transformer 25 passes along the Level 2 and Level 1 commands as Protocol 2 NOPs.

The information is then transferred via a Workcell Network 30 to the Printer Controllers 40 (controlling the basic operations of a Printer 65). As highlighted in FIG. 3 by arrows 300, 400, and 500, the Printer Controllers 40 inspects the Protocol 2 NOPs and incorporates the Level 2 commands into the PDS for printing or emits control messages via the Workcell Network 30 to the workcell peripherals based on Level 1 commands. These workcell peripherals are shown in FIG. 3 as: 1) a Print Quality System 35; and a Proprietary Print Head Control Subsystem 70 (a proprietary printing subsystem).

For additional clarification, the printing company's PDS Preprocessor 15 injects Protocol 1 NOPs into the customers' PDS file. The payload of the NOPs can be a Protocol 2 command or a Protocol 2 NOP containing another type of command targeted at a peripheral system.

At each stage of processing downstream, the software normally inspects the NOPs content and provides a simple, general purpose mechanism to either passively forward the instruction, insert the content into the print data stream, or emit control commands for peripherals. The responsible processor can emit the payload command as a Protocol 2 command or some other content to a peripheral in the workcell via a communication protocol (e.g.: SNMP or TCP/IP). An example of a printer that presents the opportunity to use the subject invention's PDS tunneling technique is a Kodak Versamark DS3700 (and equivalent devices).

The subject invention's PDS tunneling provides the following product development and operational benefits (discussed in more detail immediately below): 1) the ability to bypass logic in PDS transform applications and printer controller software; 2) the ability to create proprietary systems that are not exposed in software available to competitors; 3) the ability to control proprietary hardware and software systems in real-time; and 4) the centralized control of printer and peripherals.

1) The ability to bypass 3^{rd} party logic: as stated above, the PDS transform software and the printer controller software represent “black boxes” that are not subject to modification by the printing company. This creates delay between the development of new printing systems by the printing company due to the reliance on 3^{rd} parties to enhance their software. There is also extra complexity in design and project management. The PDS tunneling approach requires these vendors to create a very general purpose mechanism to pass along device commands.

This mechanism is general purpose and can be used in unanticipated ways in future systems as opportunities present themselves. For instance, commands in the printer vendor's data stream can be invoked even if they are not supported by the PDS Transform vendor. Other approaches to solving this problem, such as a companion summary file, add complexity and do not provide the ability to augment the PDS by submitting commands directly to the printer.

2) Ability to create proprietary systems: due to the general purpose nature of PDS tunneling, proprietary ideas and technologies are not exposed to the industry at large. The decoupling of the content of the tunneled messages from the 3^{rd} party software mechanisms allows the printing company to keep its trade secrets secret. Since the 3^{rd} party software is not required to process the specific instructions in the payload, only to forward them, no one within these vendors' organization need be informed on the use or implementation details of these proprietary systems.

3) Ability to control proprietary configurations in real-time: the close logical collocation of the print commands for a document and messages to print workcell peripherals helps create tight synchronization between the printed document and the actions of the peripheral systems. For instance, precise synchronization is required for printing of MICR or UV images from specialized print heads on specific areas of printed documents. Also, specialized print heads may be used for printing high quality symbols required for error detection and resolution in the finishing process. Of course, the system can also emit messages which are not linked to a specific print image (e.g.: for quality sampling).

4) Centralized Control of Printer and Peripherals: control of print workcell peripherals can be accomplished by the printing company's PDS Preprocessor. Messages can be embedded in customer print files for control of specialized print heads or print workcell peripherals. This allows development and operational personnel that are most familiar with customer requirements to exercise this control. Software developers and operations personnel directly involved with customer requirements can imbed controls that execute in the print operations environment.

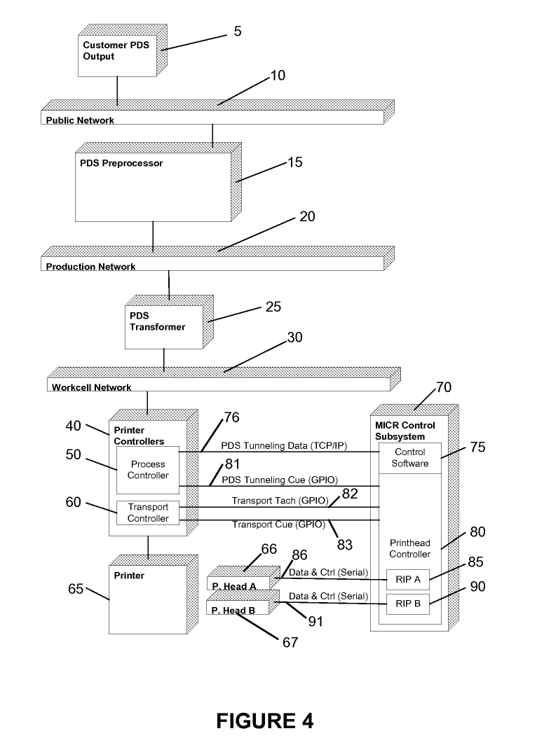

Example of a Typical Application: The block diagram seen in FIG. 4 illustrates control and data signal flow from a subject PDS Preprocessor 15 through an exemplary proprietary MICR Print Control Subsystem 70. In this example (for illustrative purposes only and not by way of limitation), two special purpose print heads 66 and 67 are controlled by raster image processors 85 and 90 (RIPs) within a Printhead Controller 80 that is within the MICR Print Control Subsystem 70 via data and control paths 86 and 91. The PDS Preprocessor 15 embeds Level 1 and Level 2 commands in the Protocol 1 data stream which are passed along to the Printer Controllers 40 by the PDS Transformer 25.

Once the PDS is received by the Printer Controllers 40, the Level 1 commands are communicated 76 (by the Process Controller 50) via a communication protocol such as TCP/IP to the Control Software 75 within the Print Control Subsystem 70. The Level 2 commands are inserted into the Protocol 2 data stream and forwarded to the primary printer for processing. Upon processing, the Process Controller 50 asserts that the image is ready to print via PDS Tunneling Cue GPIO 81 (General Purpose Input/Output) to the Print Control Subsystem 70 based on the content of the Level 2 command.

The MICR subsystem loads RIPs A 85 and/or B 90 with the Level 1 data and the RIPs acknowledge the transfer. When the image is to be printed on the Printer 65, the Process Transport Controller 60 generates a GPIO signal 83 to cue the MICR Print Control Subsystem 70.

During normal operation the Transport Controller 60 continuously transmits Transport Tach 82. The MICR Print Control Subsystem 70 monitors the Transport Tach 82 signals' values in conjunction with the GPIO 81 and 83 values. Given that PDS Tunneling Cue 81 and Transport Cue 83 are both asserted, RIPs A 85 and/or B 90 then execute the appropriate delay, based on Transport Tach 82, to position their print images properly and then render the images on the printed page.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A printing system, comprising:
a. means for embedding a tunneled message into a data stream transferred along a data path, wherein said embedded message directs the operation of an associated system along said data path and
b. means for emitting said tunneled message in a printing workcell for controlling said associated system.

2. A printing system according to claim 1, wherein a preprocessor embeds said tunneled message into said data stream.

3. A printing system according to claim 1, wherein said tunneled messages is embedded in a No Operation (NOP) command.

4. A printing system according to claim 1, wherein said associated system is selected from a group consisting of a printer, a printhead, and a print quality system.

5. A printing system, comprising:
a. means for embedding tunneled messages into a data stream transferred along a data path, wherein said embedded messages direct the operation of associated systems along said data path and
b. means for emitting said tunneled messages in a printing workcell for controlling said associated systems.

6. A printing system according to claim 5, wherein a preprocessor embeds said tunneled messages into said data stream.

7. A printing system according to claim 5, wherein said tunneled messages is embedded in a No Operation (NOP) command.

8. A printing system according to claim 5, wherein said associated systems are selected from a group consisting of a printer, a printhead, and a print quality system.

9. A printing system, comprising:
a. means for embedding tunneled messages into a data stream transferred along a data path, wherein said embedded messages direct the operation of an associated system along said data path and comprise No Operation commands and
b. means for emitting said tunneled messages in a printing workcell for controlling the associated system.

10. A printing system according to claim 9, wherein a preprocessor embeds said No Operation commands into said data stream.

11. A printing system according to claim 9, wherein said associated system is selected from a group consisting of a printer, a printhead, and a print quality system.

12. A printing system that embeds tunneled messages into a data stream transferred along a data path, wherein said embedded messages direct the operation of an associated system along the data path, comprising No Operation commands embedded by a preprocessor into the data stream and then emitted in a printing workcell for controlling the associated system.

13. A printing system according to claim 12, wherein said associated system is selected from a group consisting of a printer, a printhead, and a print quality system.

14. A printing system that embeds tunneled messages into a data stream transferred along a data path, wherein said embedded messages direct the operation of an associated device along the data path, comprising No Operation commands embedded by a preprocessor into the data stream and then emitted in a printing workcell for controlling the associated device.

15. A printing system according to claim 14, wherein said associated device is selected from a group consisting of a printer, a printhead, and a print quality system.

16. A method for controlling the operation of a printing system, comprising:
a. embedding a tunneled message into a data stream transferred along a data path, wherein said embedded message directs the operation of an associated system along said data path and
b. emitting said tunneled message in a printing workcell for controlling said associated system.

17. A printing system method according to claim 16, wherein a preprocessor embeds said tunneled message into said data stream.

18. A printing system according to claim 16, wherein said tunneled messages is embedded in a No Operation (NOP) command.

19. A printing system according to claim 16, wherein said associated system is selected from a group consisting of a printer, a printhead, and a print quality system.

20. A method for controlling a printing system, comprising the steps:
a. embedding a tunneled message into a data stream, wherein said embedded tunneled message is intended for controlling an associated system along said data path;
b. using No Operation commands embedded by a preprocessor into said data stream to carry said tunneled message; and
c. emitting said message in a printer workcell for controlling said associated system.

21. A printing system method according to claim 20, wherein said associated system is selected from a group consisting of a printer, a printhead, and a print quality system.

22. A method of printer and peripheral device control in a printing system, comprising the steps:
a. embedding tunneled messages into a data stream, wherein said embedded tunneled messages are intended for controlling operation of the printer and the peripheral device along said data path;
b. using No Operation commands embedded by a preprocessor into said data stream to carry said tunneled messages; and
c. emitting said messages in a printer workcell for controlling the printer and peripheral device.
